(19) United States
(12) Patent Application Publication
(10) Pub. No.: US 2020/0287480 A1
(43) Pub. Date: Sep. 10, 2020

(54) ELECTRICAL POWER GENERATING APPARATUS

(71) Applicant: Eugene A. Giannotta, Naples, FL (US)

(72) Inventor: Eugene A. Giannotta, Naples, FL (US)

(73) Assignee: The Washington Group, LLC, Naples, FL (US)

(21) Appl. No.: 16/294,267

(22) Filed: Mar. 6, 2019

(51) Int. Cl. H02N 99/00; H02J 50/10; H01F 38/14; H01F 27/24; E01H 5/10

(52) U.S. Cl. CPC H02N 99/00; H02J 50/10; E01H 5/10; H01F 27/24; H01F 38/14

(57) ABSTRACT

An electrical power generating platform/apparatus is disclosed. One or more platforms positioned on a surface, for example, highways. The platform comprises a plurality of strips. Each strip is incorporated with a plurality of windings wrapped around a metal core. The platforms can be connected to each other. One or more devices producing magnetic fields are affixed to a bottom portion of an object. When the object moves, the devices producing magnetic fields over or near or through the plurality of windings of the strips in the platform, that causes a generation of an electric current which is transferred to the power grid and/or power storage devices via conductors. The platform further comprises one or more resistive conductors affixed to a top portion of the platform, wherein the resistive conductors heat up on flow of electric current to melt the snow and ice that would otherwise accumulate on the platform.

### BACKGROUND OF THE INVENTION

### A. Technical Field

The present invention generally relates to a power generating apparatus. Specifically, the present invention relates to a power generating apparatus configured to generate electrical current from moving objects, for example, vehicles.

### B. Description of Related Art

Energy demand across the world has increased rapidly in recent decades with economic growth and the spread of industrialization in developing countries. Currently, there are many different types of electric power generating plants operating to produce power from renewable and non-renewable energy sources to meet the world's energy needs. Power generation broadly comes from sources such as coal, nuclear, natural gas, hydroelectric, wind, oil, solar, geothermal sources, etc. Power generation from oil, coal, and similar sources typically leads to pollution and is thought to contribute to global warming. Power generation from nuclear raises safety and security concerns.

Additionally, much of the electricity generated from more recently installed renewable energy sources has been more costly than non-renewable resources and has its own unintended environmental consequences. Some examples of unintended environmental consequences are that wind turbines kill large numbers of birds every year; ground based solar power systems consume large swaths of land; and solar panels are manufactured with hazardous materials. Thus, there is a significant need to generate electrical power from other cost-effective sources to meet the world's energy needs without causing pollution or other unintended environmental consequences.

A prior art, U.S. Pat. No. 7,164,211 of Tafoya et al., discloses a system and method for generating electric current from automobiles. The system includes power pods having multiple permanent magnets or coils of wire. The power pods could be installed within the heavily trafficked roadway surfaces and railroad beds. When vehicles pass over the power pods, the permanent magnets or coils of wire create a current routed for productive use. But one of the numerous commercial limitations of this system is the enormous costs that would be incurred by digging up existing roadway surfaces to embed power pods into roadways, as well as ongoing costs of re-excavating sections of roadways when inevitable maintenance is required.

Another prior art, U.S. Pat. No. 10,135,376 of Brier et al., discloses a regenerative energy system to produce energy from moving vehicles using magnetic induction. The system consists of a ground transportation vehicle having one or more magnetic elements attached to the underside of the vehicle, one or more magnetic coil assembly consisting of a core and magnetic coil installed in an adjacent and spaced out manner along a travel route. The vehicles are accordingly operable to accelerate and decelerate when the vehicles are proximate to a magnetic coil assembly for generating electrical current. The artwork clearly shows the vehicle traveling on railroad tracks. This system also looks to be highly impractical for generating electrical power.

Accordingly, there is a need for a power generating apparatus to efficiently generate electrical power from moving objects, for example vehicles, with negligible environmental impact and negligible impact to existing vehicle motion. There is also a need for a power generating apparatus simply installed on the surfaces, for example, highways and roadways without digging up the surfaces. There is also a need for a power generating apparatus to prevent snow and ice accumulation on the surfaces where it is placed in regions where snow and ice occur; and as a result, the apparatus also significantly reduces damages to roadways, highways, and bridges that would otherwise be damaged by snow and ice removal via snow plows, road salts, and other de-icing chemicals. There is also a need for a power generating apparatus to protect the surface or layer on which it is placed. This will extend the life span of surfaces, for example, highways; which means their replacement costs are significantly deferred. An additional benefit of this invention is that any pre-damaged surfaces, such as but not limited to; surfaces with pot holes and/or significant cracks, the vehicles or objects will no longer encounter the damaged surfaces but will instead move along a level solid surface and thus encounter a much smoother and safer experience.

### SUMMARY OF THE INVENTION

The present invention generally discloses a power generating apparatus. The present invention directed to a power generating platform/apparatus configured to generate electrical power from moving objects, for example, vehicles.

In one embodiment, one or more platforms positioned on a surface. The platform is a protective platform. In one embodiment, the surface includes, but not limited to, streets, highways, on-ramps, off-ramps, and roads. In one embodiment, the platforms could be connected to each other via connectors. In one embodiment, the electrical contents of the platforms could be connected to each other via conductors. In one embodiment, the platform comprises a plurality of strips. A strip is a bar, but not limited to a magnet wire wrapped bar. In one embodiment, the strips are made of ferrous metal including, but not limited to steel and/or metal alloys. In one embodiment, the platforms are made of a non-ferrous metal including, but not limited to, aluminum, manganese steel and/or a combination of non-ferrous metal alloys. In one embodiment, the strips are arranged in any one of a column configuration or a row configuration to maximize the efficiency of the platform. In one embodiment, the platforms further comprise sloping surfaces around outside exterior sides to bridge the top of the platforms to the surfaces they are placed onto in order to allow for smooth traveling of the vehicle on and off said protective platforms.

In one embodiment, each strip is incorporated with a plurality of windings wrapped around at least one metal core. In one embodiment, the metal core is at least any one of a ferrous metal core or a steel metal core. In one embodiment, the plurality of windings is magnet wire windings. In one embodiment, the plurality of winding acts as a closed circuit. In another embodiment the plurality of windings is wrapped around at least one non-metal core. In another embodiment the plurality of windings is not wrapped around any core. In one preferred embodiment, a plurality of windings forms a grouping of windings or grouping of conductive windings which is clearly separated by spacing from at least, but not limited to, another grouping of windings or grouping of conductive windings along the same strip, and yet the groupings of windings or grouping of conductive windings are connected by conductor(s). In one preferred embodiment, the objective is to maximize the plurality of windings on the strips that can be reached by magnetic fields in order to maximize the current generated.

In one embodiment, one or more devices are affixed to a bottom portion of a vehicle. In another embodiment, the devices are affixed to tire portions of the vehicle. In some embodiments, the devices are affixed to tire rims of the vehicle. In one embodiment, the devices are made of magnetic elements. In one embodiment, the devices of the vehicle are in close proximity to the plurality of windings when the vehicle passes over the platform, thereby an electric current is generated in the plurality of windings of the strips due to change/movement in magnetic field and transferred to a power grid via conductors. In one embodiment, the devices of the vehicle have protective coating(s) and/or cover(s) and/or shielding to protect them from damages/breaks due to potential contacts with road surfaces or other hazards. In one embodiment, the vehicle devices are disposed with respect to the tire axis or axes of the vehicles.

In one embodiment, the platform further comprises a cover. In one embodiment, the cover is configured to protect the windings and the strips in the platform. In one embodiment the cover is comprised of a non-slip surface. In one embodiment, the cover further comprises one or more resistive conductors. In one embodiment, the resistive conductors are affixed to a top portion of the cover, wherein the resistive conductors heat up on the flow of electric current to melt the snow and/or ice that would otherwise accumulate on the platform. In one embodiment, the resistive conductors are embedded inside the cover, wherein the resistive conductors heat up on the flow of electric current to melt the snow and/or ice that would otherwise accumulate on the platform. In one embodiment, the resistive conductors are affixed to a top portion of the cover and embedded inside the cover.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 shows an inside overhead open view of a platform containing strips, in an embodiment of the present invention.

FIG. 2 shows a side sectional view of a platform that includes strips in one embodiment of the present invention.

FIG. 3A shows an overhead view of a plurality of magnet wire windings wrapped around a metal core in one embodiment of the present invention.

FIG. 3B shows a side view of a plurality of windings wrapped around the metal core in one embodiment of the present invention.

FIG. 4 shows an underside view of a vehicle which includes at least 2 magnetic devices affixed to the underside of the vehicle in one embodiment of the present invention.

FIG. 5 shows an underside view of a vehicle which includes at least 4 magnetic devices affixed to the underside of a vehicle in another embodiment of the present invention.

FIG. 6 shows a front view of a vehicle which includes at least 4 magnetic devices affixed to the underside of a vehicle in another embodiment of the present invention.

FIG. 7 shows a front view of a tractor of a semi-trailer truck which includes at least 4 magnetic devices affixed to the underside of the truck in another embodiment of the present invention.

FIG. 8 shows a side view of a tandem trailer of a semi-trailer truck which includes at least 6 magnetic devices affixed to the underside of the trailers in one embodiment of the present invention.

FIG. 9A shows an overhead exterior view of a cover of the platform of the electrical power generating apparatus in one embodiment of the present invention.

FIG. 9B shows the underside view of a cover of the platform that includes resistive conductors in one embodiment of the present invention.

FIG. 10A shows an overhead view of an empty platform in one embodiment of the present invention.

FIG. 10B shows a rear side view of the empty platform in one embodiment of the present invention.

FIG. 11 shows a top view of multiple parallel platforms in a configuration positioned on the surface in one embodiment of the present invention.

FIG. 12 shows a top view of the platforms positioned on and across the surface in another embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

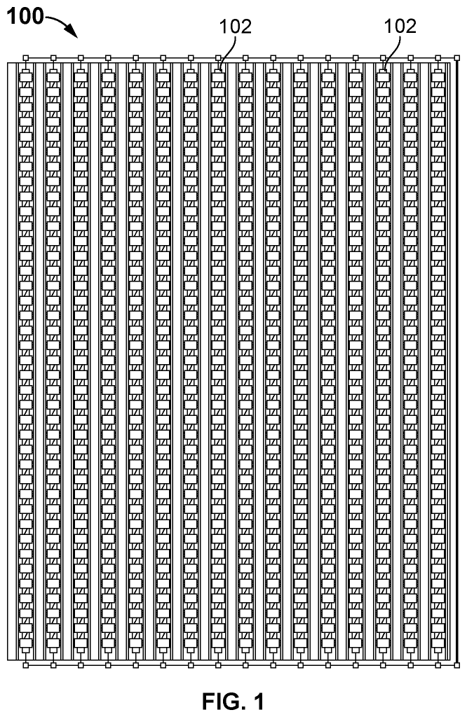

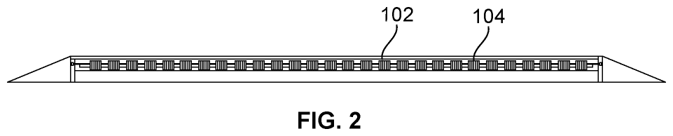

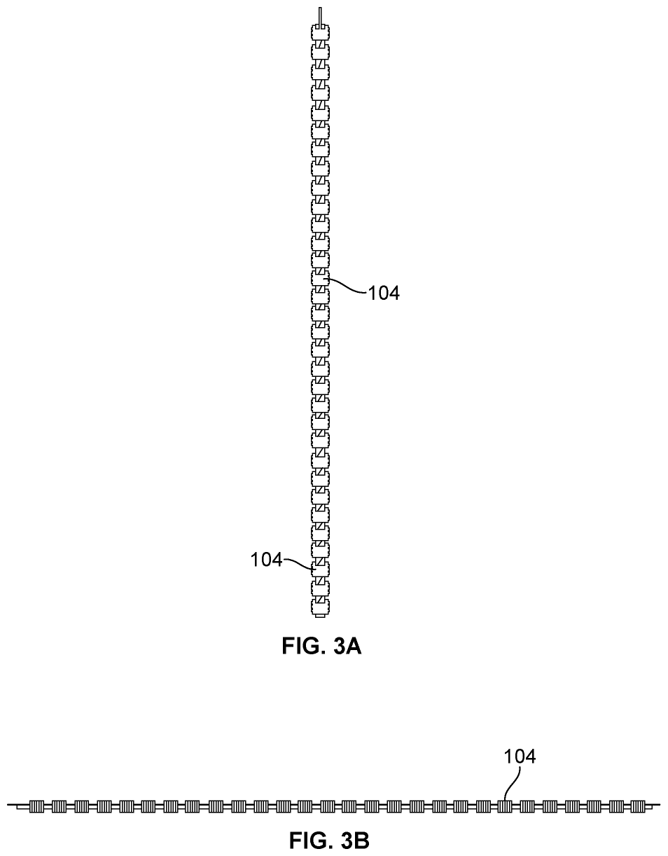

Referring to FIG. 1, an electric power generating platform/apparatus 100 used to generate electric power. In one embodiment, the platform 100 comprises a plurality of strips 102. In one embodiment, each strip 102 is incorporated with a plurality of windings 104 (shown in FIG. 2) wrapped around at least one metal core. The strip 102 is a bar, but not limited to a magnet wire wrapped bar. In some embodiments, the plurality of windings 104 (shown in FIGS. 2, 3A, 3B) need not wrap around any metal core, for example, but not limited to, steel and/or ferrous metal cores, or any core at all. In one embodiment, the strips 102 are arranged in the platform in a column configuration to maximize the efficiency inside the platform 100. In another embodiment, the strips 102 are arranged inside the platform in a row configuration. In one embodiment, the metal core is a steel metal core. In another embodiment, the metal core is a ferrous metal core. In another embodiment, the ferrous metal core is made out of another ferrous metal or metal alloy(s). In one embodiment the ferrous metal core is a flat bar stock. In another embodiment the ferrous metal core is a round bar stock. In another embodiment the ferrous metal core is non-metal.

In some embodiments, the platform 100 could be placed on a top surface and/or affixed to, surfaces wherever objects or vehicles or vehicle attachments could travel, i.e. surfaces such as, but not limited to, streets, highways, on and/or off ramps, and roads. In one embodiment, the platforms 100 could be connected to each other. In one embodiment, an insulated electrical conductor is used to connect the electrical contents of the individual platforms 100 with the electrical power grid, and/or to connect the contents of multiple platforms 100 with the electrical power grid. In one embodiment, insulated electrical conductor(s) will be used to transport electricity.

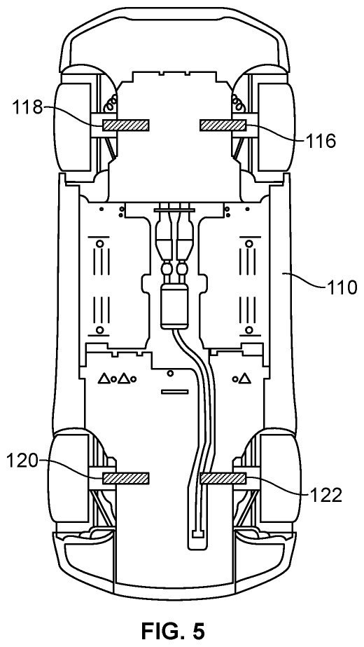

In one embodiment, one or more devices (112 and 114) (shown in FIG. 5) that produce a magnetic field, affixed to a bottom of an object or vehicle 110 in the front and/or rear tire axes general portions of any vehicle 110 (shown in FIG. 5), for example, but not limited to, a car. In one embodiment, the devices (112 and 114) (shown in FIG. 5) are magnetic devices. In one embodiment, the magnetic devices (112 and 114) (shown in FIG. 5) produce a magnetic field and when the vehicle 110 (shown in FIG. 5) moves the magnetic field by driving over the platform 100, an electric current is generated in the plurality of magnet wire windings 104 (shown in FIGS. 2, 3A, 3B.) on the strips 102 in the platform 100. In one embodiment, the vehicle 110 is at least any one of cars, trucks, buses, semi-trucks, semi-trucks with trailer, tractor trailers, trailers, RVs, SUVs, campers, limousines, cabs, vans or any other means in or by which someone travels or something is carried or conveyed or transported or any attachments to the vehicles. In a preferred embodiment, the platform 100 has a thickness/height of about, but not limited to, 1.25 inches.

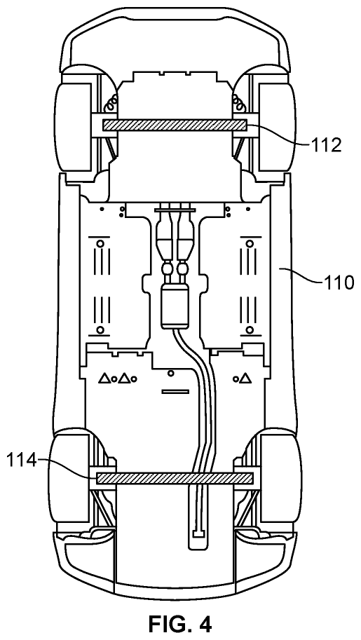

Referring to FIG. 2, the strip 102 is positioned in the platform 100. In one embodiment, the plurality of windings 104 of each strip 102 is connected to each other to form an individual closed circuit. In another embodiment one or more groups of windings form a closed circuit. In another embodiment, the plurality of windings 104 of at least one strip 102 are connected to the plurality of windings 104 of at least one more strip 102 to form a closed circuit. In one embodiment, the plurality of windings 104 is a plurality of magnet wire windings. In one embodiment, the platforms 100 are made of a non-ferrous material such as, but not limited to: aluminum, manganese steel, and/or a combination of materials that will not interfere with the magnetic field emitted by the magnetic devices (112 and 114) (shown in FIG. 4). In one embodiment, the plurality of windings 104 of the strips 102 positioned in the platform 100 should be perpendicular or close to perpendicular, to the magnetic fields passing overhead or nearby or through, in order to generate electric current in the plurality of windings 104. In one embodiment, strips 102 are separated from other columns of strips 102, by a column/wall of non-ferrous material. In one embodiment, the columns/rows of strips 102 are contained inside their own channel. In one embodiment the columns/walls of non-ferrous material are roughly all the same size. In another embodiment the columns/walls of non-ferrous material are of more than one size. In one embodiment the columns/rows holding the strips 102 are roughly all the same size. In another embodiment, the columns/rows holding the strips 102 are of more than one size. In one embodiment, the non-ferrous material is made of, but not limited to: aluminum, manganese steel, and/or a combination of materials that will not attract/interfere with the magnetic field emitted by the devices, for example, magnetic devices.

In one preferred embodiment, a plurality of windings 104 forms a grouping of windings or grouping of conductive windings which is clearly separated by spacing from at least, but not limited to, another grouping of windings or grouping of conductive windings along the same strip 102, and yet the groupings of windings or grouping of conductive windings are connected by conductor(s). In one preferred embodiment, the objective is to maximize the plurality of windings 104 on the strips 102 that can be reached by magnetic fields in order to maximize the current generated.

In one embodiment, the strips 102 could be fastened/adhered to a bottom portion of the platform 100 to keep the strips 104 stable in the platform 100. In another embodiment, the strips 102 could be fastened/adhered to a portion of the platform 100 to keep the strips 102 stable in the platform 100.

In one embodiment, the platforms 100 include sloped/inclined surfaces around the exterior outside portions for smooth traveling of the vehicles on and off the platforms 100. In one embodiment, the inclined/sloped surfaces of the strips 102 bridge the top portion of the platforms with the surface on which they are placed. In another embodiment, if the platforms 100 are positioned in close proximity to the side(s) of other platforms, then those platform's sides do not require sloped/inclined surfaces around the exterior side portions. In some embodiments, the platforms 100 do not have any sloped/inclined surfaces around the exterior outside portions. In some embodiments, only a specific exterior outside portion, or portions of the platforms 100 have inclined/sloping surfaces.

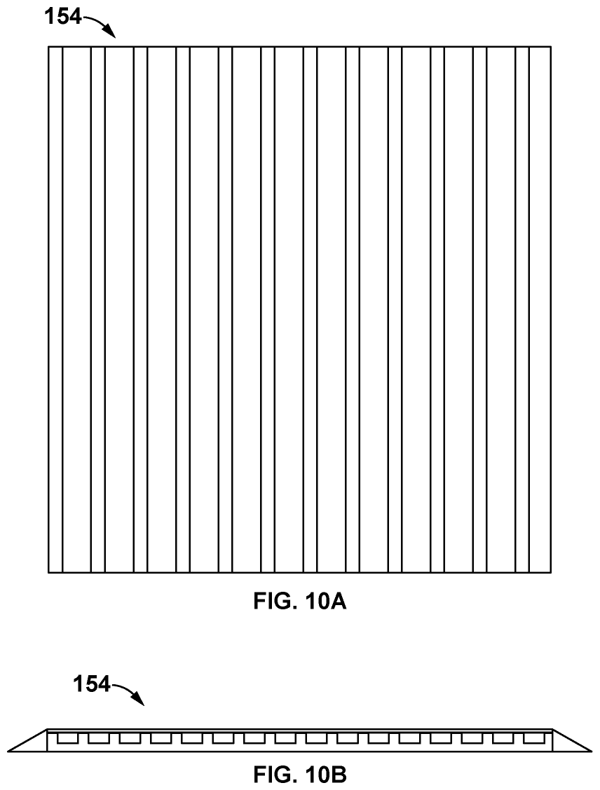

Referring to FIGS. 3A-3B, the plurality of windings 104 wrapped around a metal core. In one embodiment, the plurality of windings 104 are magnet wire windings. In some embodiments, the plurality of windings 104 do not needed to wrap around a metal core. The strips 102 (shown in FIG. 1) are arranged in the platform 100 (shown in FIG. 1) in any one of, but not limited to, a column configuration or a row configuration to maximize the efficiency of the platform 100 (shown in FIG. 1). In a preferred embodiment of the present invention, the plurality of windings 104 is arranged in the column configuration. In a preferred embodiment of the present invention, it would be efficient to exclude the plurality of windings 104 from areas in the platform 154 (shown in FIG. 10A) where the overhead and/or nearby magnetic field will not reach them.

In one embodiment, the plurality of windings 104 of at least one platform 100 (shown in FIG. 1) are connected to other plurality of windings of at least one or more platforms via insulated electrical conductor(s) to transfer the generated electrical current, for example, but not limited to, the power grid. In one embodiment, the plurality of windings 104 of one platform 100 (shown in FIG. 1) are connected via insulated electrical conductor(s) to transfer the generated electrical current, for example, but not limited to, the power grid. In one embodiment, the power generating platform/apparatus 100(shown in FIG. 1) is configured to generate direct current (DC) current. In a preferred embodiment, the generated electric current is converted from DC current into alternating current (AC) using one or more power inverters before transferring or feeding the current to the power grid. In some embodiments, the power generating platform/apparatus 100 (shown in FIG. 1) is configured to generate AC current.

Referring to FIG. 4, the vehicle 110 includes more than one magnetic device (112 and 114) that produce a magnetic field in one embodiment of the present invention. In one embodiment, the magnetic devices (112 and 114) are affixed to, but not limited to, the bottom portion of the vehicle 110 in order to reach the magnetic field to the plurality of windings 104 (shown in FIG. 2) of the strips 102 (shown in FIG. 2) when the vehicle passes over the platform 100 (shown in FIG. 1) for generating electric current in the plurality of windings 104 (shown in FIG. 2). In one embodiment, the magnetic devices (112 and 114) could be, but are not limited to, magnetic elements, neodymium magnets, electromagnets. In one embodiment, the magnetic devices (112 and 114) could be of any variety of lengths, widths or dimensions. In one embodiment, the magnetic devices (112 and 114) also have protective coating(s) and/or cover(s) and/or shielding to protect them from damages/breaks due to potential contacts with road surfaces or other hazards. In one embodiment the magnetic devices (112 and 114) are disposed with respect to the front and/or rear tire axes of the vehicle 110. In one embodiment, a key limiting factor in determining the size and number of magnetic devices on an object is cost.

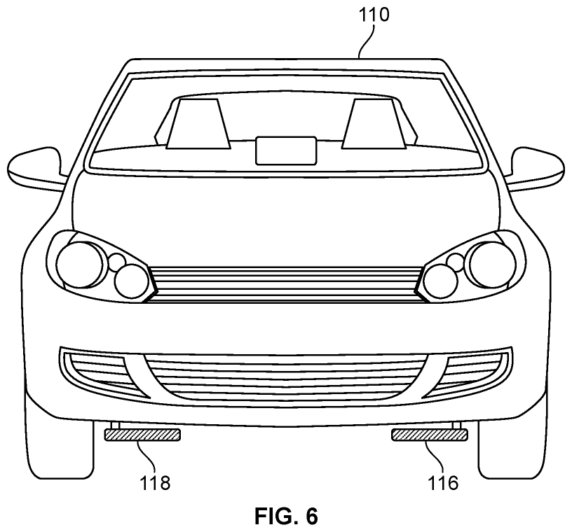

Referring to FIGS. 5-6, the vehicle 110 includes multiple magnetic devices (116, 118, 120 and 122). In one embodiment, the magnetic devices (116, 118, 120 and 122) could be, but are not limited to, magnetic elements, neodymium magnets, electromagnets. In one embodiment, the magnetic devices (116, 118, 120 and 122) are affixed to, but not limited to, the bottom portion of the vehicle 110 in order to reach the magnetic field to the plurality of windings 104 (shown in FIG. 2) of the strips 102 (shown in FIG. 2) for generating electric current. In one embodiment, the devices (116, 118, 120 and 122) are further comprised of protective coating(s), and/or cover(s), and/or shielding to protect them from damages/breaks due to potential contacts with road surfaces or other hazards. In one embodiment the magnetic devices (116, 118, 120 and 122) are disposed with respect to the front and/or rear tire axes of the vehicle 110. In one embodiment a key limiting factor in determining the size and number of magnetic devices on an object is cost.

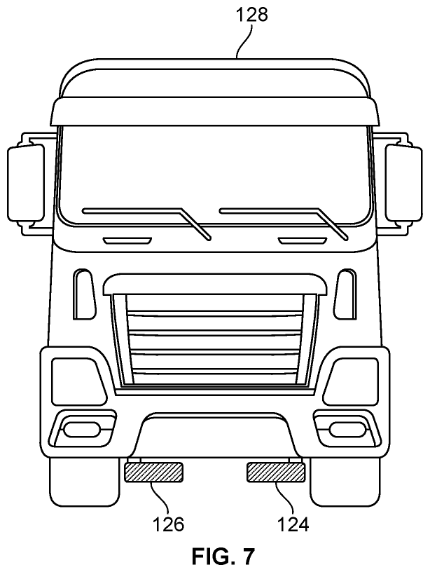

Referring to FIG. 7, more than one magnetic device (124 and 126) disposed to, but not limited to, a bottom portion of a semi-trailer truck 128. In one embodiment, the magnetic devices (124 and 126) could be, but are not limited to, neodymium magnets, other magnetic elements, and/or electromagnets. In one embodiment the magnetic devices (124 and 126) are disposed with respect to the front and/or rear tire axes. The magnetic devices (124 and 126) are in close proximity to the plurality of windings 104 (shown in FIG. 2) on the strips 102 (shown in FIG. 2) when the semi-trailer truck 128 passes over the platform 100 (shown in FIG. 1), thereby generating an electric current in the plurality of windings 104 (shown in FIG. 2). In one embodiment, the magnetic devices (124 and 126) are also comprised of protective coating(s), and/or cover(s), and/or shielding, to protect them from damages/breaks due to potential contacts with road surfaces or other hazards. In one embodiment a key limiting factor in determining the size and number of magnetic devices on an object is cost.

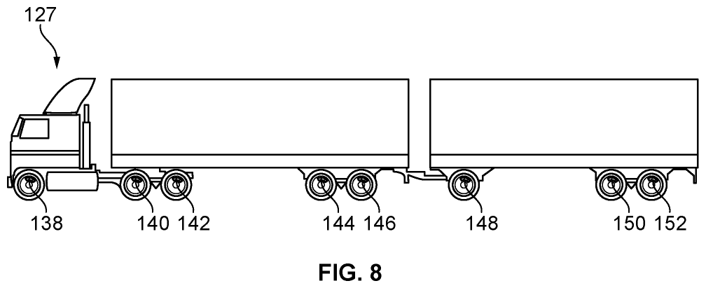

Referring to FIG. 8, a semi-truck and trailer 127 includes magnetic devices (138, 140, 142 144, 146, 148, 150, and 152) disposed with respect to the front and rear tire axes portions of the semi-truck and trailer 127. In one embodiment, the magnetic devices (138, 140, 142 144, 146, 148, 150, and 152) are, but not limited to, neodymium magnets, other magnetic elements, and/or electromagnets. The semi-truck and trailer 127 could travel over the power generating protective platforms 100 disposed on a surface, for example, streets, highways, on-ramps, off-ramps, and roads. In one embodiment, the platform 100 includes plurality of strips 102 (shown in FIG. 2). In one embodiment, the magnetic devices (138, 140, 142 144, 146, 148, 150, and 152) are in close proximity to the plurality of windings 104 (shown in FIG. 2) of the strips 102 (shown in FIG. 2) and when the magnetic devices (138, 140, 142 144, 146, 148, 150, and 152) are moved by the vehicle 110 pass over the platform 100, an electric current is thereby generated in the plurality of windings 104 (shown in FIG. 2). In one embodiment, the devices (138, 140, 142, 144, 146, 148, 150 and 152) are further comprised of protective coating(s), and/or cover(s), and/or shielding to protect them from damages/breaks due to potential contacts with road surfaces or other hazards. In one embodiment, a key limiting factor in determining the size and number of magnetic devices on an object is cost.

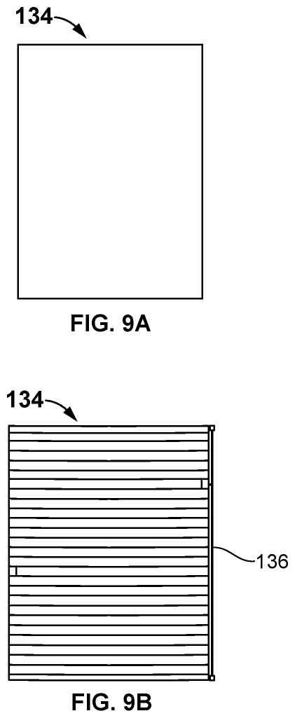

Referring to FIGS. 9A-9B, the platform 100 further comprises a top portion or a cover 134. The cover 134 is configured to protect the windings 104 (shown in FIG. 2) and strips 102 (shown in FIG. 2) of the platform 100 (shown in FIG. 1). In one embodiment, the cover 134 comprises a non-slip surface. In one embodiment, the cover 134 is positioned on the platform 100 (shown in FIG. 1) with a seal, for example, but not limited to, a rubber seal. In one embodiment, the seal is configured to prevent water and/or moisture leakages into the platform 100 (shown in FIG. 1) and to keep the inside contents of the platform 100 (shown in FIG. 1) dry. In one embodiment the cover 134 could be opened and/or closed for easy access to the platform 100 (shown in FIG. 1) and strips 102 (shown in FIG. 2) of the platform 100. In one embodiment the cover 134 is not opened and/or closed for easy access to the platform 100 (shown in FIG. 1) and strips 102 (shown in FIG. 2) of the platform 100. In one embodiment, the cover 134 is provided with one or more resistive conductors 136 for melting ice and/or snow to prevent them from accumulating on the platforms 100. In one embodiment, the resistive conductors 136 are affixed or integrated to, but not limited to, a top portion 134 of the platform cover 100. In some embodiments, the resistive conductors 136 are affixed or integrated to, but not limited to, an underside of the platform cover 134. In one embodiment, the resistive conductors 136 heat up on the flow of electric current to melt the snow and/or ice that would otherwise accumulate on the platforms 100. In one embodiment, the resistive conductors 136 are made of non-ferrous materials. The non-ferrous materials are used because of desirable properties such as non-magnetic property. The resistive conductors 136 don't interfere with the magnetic fields. In an exemplary embodiment, the resistive conductors 136 could be connected to but are not limited to, insulated electric conductor(s) to provide current to the resistive conductors 136 of the platform covers 134.

Referring to FIGS. 10A-10B, an empty platform 154 is configured to receive the plurality of strips 102 (show in FIG. 1).

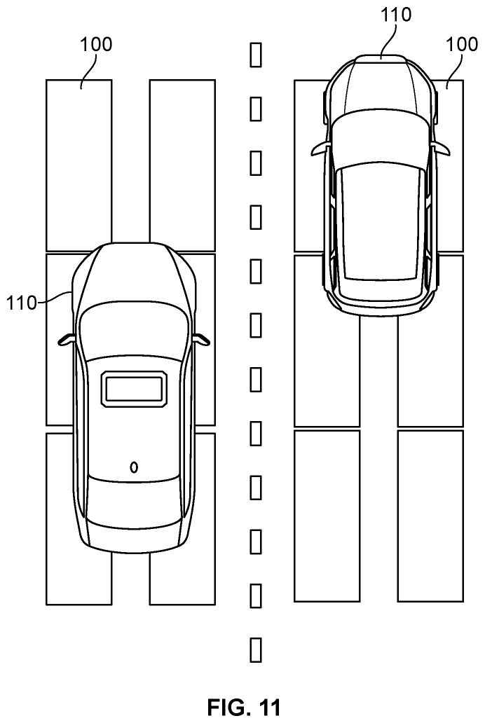

Referring to FIG. 11, the platforms 100 are in a configuration positioned on the surface, for example, but not limited to, roadways and highways. In an exemplary embodiment, the platforms 100 located on the surfaces in the configuration relative to where devices, such as magnets are placed on the under portions of the vehicles 110.

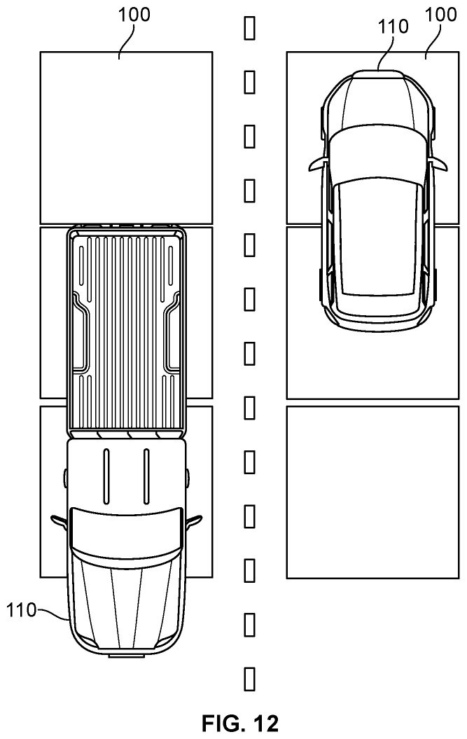

Referring to FIG. 12, the platforms 100 are positioned on the surface, for example, but not limited to, roadways and highways. In an exemplary embodiment, the platform 100 could cover the entire width of a roadway. In regions where snow and/or ice occur, the platform 100 could melt the ice and/or snow to prevent ice and/or snow accumulation on the platform 100 and the roadway. In another embodiment, the strips 102 (shown in FIG. 1) are positioned at desired or selected areas inside the platforms 100. The position of the strips 102 (shown in FIG. 1) will depend on the standardized location of the devices/magnetic device on the objects they are affixed to.

The platform 100 efficiently generates electrical power from moving vehicles and with negligible environment impact and negligible impact to existing vehicle motion. It is simply installed on the surfaces, for example, highways and roadways. The platform 100 is a cost effective and simple power generating apparatus for generating and supplying electricity. In cold weather regions the platform 100 could contain an additional feature to prevent snow and ice from accumulating on the platforms and on the surfaces; that will reduce the damage to roadways, highways, bridges, etc. and the environment that is currently caused by snow and ice removal by snow plows, road salts, and/or de-icing chemicals.

The power generating apparatus/platform 100 protects the surface or layer, for example, highways, on which it is placed. This will extend the life span of surfaces, for example, highways; which means their replacement costs are significantly deferred. An additional benefit of this invention is that any pre-damaged surfaces, such as but not limited to, surfaces with pot holes and/or significant cracks, vehicles or objects will no longer encounter the damaged surfaces but will instead move along a level solid surface and thus encounter a much smoother and safer experience.

Although some embodiments of the invention have been illustrated in the accompanying drawings and described in the above detailed description, it will be understood that the invention is not limited to the embodiments developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in a generic and descriptive sense and not for purposes of limitation. Accordingly, the present invention is not limited to the specific embodiments illustrated herein.

What is claimed is:

1. An electric power generating apparatus, comprising:
one or more platforms positioned on a surface,
wherein the platform comprises a plurality of strips,
wherein each strip is incorporated with a plurality of windings wrapped around at least one metal core;
one or more devices emitting magnetic fields are affixed to a bottom portion of an object,
wherein the movement of the devices by the object(s) passing over or near or through the plurality of windings of the strips in the platform, causes a generation of an electric current, wherein the generated electric current is transferred to a power grid via conductors.

2. The apparatus of claim 1, where in the surface is any one or more of streets, roads, avenues, paths, highways, expressways, freeways, thruways, interstates, superhighways, turnpikes, arteries, parkways, on-ramps, off-ramps, tunnels, bridges, railroad tracks, tracks, sidewalks, walkways, paths, trails, floors.

3. The apparatus of claim 1, wherein the plurality of windings are magnet wire windings and the plurality of windings of at least one strip form a closed circuit.

4. The apparatus of claim 1, wherein the metal core is at least any one of a ferrous metal core and a steel metal core.

5. The apparatus of claim 1, wherein the platforms are made of a non-ferrous metal including aluminum, manganese steel, and/or a combination of non-ferrous metal alloys.

6. The apparatus of claim 1, where in the platforms further comprise sloping surfaces around outside exterior sides of the platforms, to bridge the tops of the platforms with the surfaces on which they are placed, for smooth traveling of object(s) on and/or off said platforms.

7. The apparatus of claim 1, wherein the plurality of strips is fastened/adhered to a portion of the platform to keep the strips stable in the platform.

8. The apparatus of claim 1, wherein the strips are arranged in any one of a column configuration or a row configuration to maximize the content efficiency of the apparatus.

9. The apparatus of claim 1, wherein the devices that emit magnetic fields are affixed to underside of the object(s) and yet are in close enough proximity to the platforms for the magnetic fields to reach the plurality of windings inside the platform(s) in order to generate an electric current.

10. The apparatus of claim 1, wherein the devices are made of magnetic element(s) and wherein the devices comprise a protective cover and/or coating(s), and/or shielding to prevent from damages due to potential contacts with the surfaces or other hazards.

11. The apparatus of claim 1, wherein the platform is configured to protect electrical contents include the plurality of windings, strips, and the surface on which it resides.

12. The apparatus of claim 1, wherein the platforms are leveled and thus objects traveling/moving on the platforms encounter a smooth and safe experience.

13. The apparatus of claim 1, wherein the plurality of windings of any one or more platform(s) connect to the electric power grid or power storage unit(s) via one or more conductors.

14. The apparatus of claim 1, wherein the generated electric current in the plurality of windings is direct current (DC) and converted to an alternating current (AC) via at least one inverter before being transferred to a power grid.

15. The apparatus of claim 1 wherein the plurality of windings forms a grouping of windings which is separated by spacing from another grouping of windings along the same strip and the groupings of windings are connected via a conductor and/or strip.

16. The apparatus of claim 1, wherein the plurality of windings forms a grouping of conductive windings and clearly separated from the adjacent grouping of conductive windings along the strip, wherein the grouping(s) of conductive windings is connected together by conductor(s) to form closed circuits.

17. The apparatus of claim 16, wherein the grouping of conductive windings causes generating of an electric current in the conductive windings when the movement of a magnetic field passing over and/or in close proximity to and/or through the groupings of conductive windings.

18. The apparatus of claim 1, further comprises one or more resistive conductors affixed or integrated to a top cover of the platform, wherein the resistive conductors heat up upon the flow of electric current from a power source via one or more conductors to melt the snow and/or ice that would otherwise accumulate on the top of the platform.

19. The apparatus of claim 18, wherein the cover of the platform comprises a non-slip surface.

20. The apparatus of claim 18, wherein in the cover of the platform is configured to open and close on the platform.
